(19) United States
(12) Patent Application Publication
(10) Pub. No.: US 2016/0068277 A1
(43) Pub. Date: Mar. 10, 2016

(54) Unmanned Aircraft Systems Ground Support Platform

(71) Applicant: Salvatore Manitta, Tuxill Square, NY (US)

(72) Inventor: Salvatore Manitta, Tuxill Square, NY (US)

(21) Appl. No.: 14/793,708

(22) Filed: Jul. 7, 2015

Related U.S. Application Data
(60) Provisional application No. 62/021,928, filed on Jul. 8, 2014.

(51) Int. Cl. B64F 1/00; B64C 39/02

(52) U.S. Cl. CPC B64F 1/00; B64C 39/024

(57) ABSTRACT

The Unmanned Aircraft Systems ground support platform is a portable, multifunctional apparatus to accommodate UAS (Drone, UAV) landings, takeoffs, idle time, maintenance, retail merchandise product display and package delivery support within the UAS recreational and business industry. The Unmanned Aircraft Systems ground support platform will provide stability and cleanliness of a Unmanned Aerial Vehicle. Ownership identification is intergraded into the base platform.

### CROSS-REFERENCE TO RELATED APPLICATIONS

Provisional application, number: 62/021,928

### STATEMENT REGARDING FEDERALLY SPONSORED RESEARCH AND DEVELOPMENT

### REFERENCE TO A SEQUENCE LISTING, A TABLE, OR A COMPUTER PROGRAM LISTING COMPACT DISC APPENDIX

Not Applicable.

### BACKGROUND OF THE INVENTION

U.S. patent classification: 244/114R

Statement in the field of endeavor: Portable Unmanned Aircraft System landing platform.

UAS's (Drones, Unmanned Aerial Vehicles, quadcopters) have become a popular form of recreation and business. The remote control quadcopter hobby is well established. UAS's carrying cameras for photography, the film industry and inspection are becoming more mainstream. Future use with UAS's will include home and business package delivery. Drones carrying sensors to scan farm fields to improve agriculture and the environment are in use today. A common concern is safe, clean landings and take offs.

UAS's can be expensive.

A UAS's payload can be expensive (cameras, sensors, lifesaving equipment, retail packages).

UAS's can be fragile.

UAS's have adequate landing gear but, they are susceptible to outdoor ground (earth) and weather conditions. Wet, sandy beach, dust from soil and grass can impede a good, safe landing and take off. The UAS undercarriage, propellers and camera/sensor are susceptible to dirt and debris.

UAS ownership identification may be difficult if similar style, brand is in use by a group of people.

UAS ground take off/landing areas need safety precautions.

UAS package delivery support and confirmation need to be obtained.

### BRIEF SUMMARY OF THE INVENTION

The present invention overcomes the difficulties and concerns described above by integrating structure, visual identification, lighting, product ownership identification and safety labeling. The UAS ground support platform has multi-functional use, both in recreational and business. The invention supports UAS landings, take offs, idle time, maintenance, package delivery and merchandise retailer static display. The invention is portable. The invention is lightweight: The invention is functionally designed for indoor and outdoor use at home, business, beach, boat, back of pickup truck, etc. The invention has a small footprint. Platform size is 24 inches square and three and half inches deep. Another size is 36 inches square and three and half inches deep. The invention is designed to provide a stable, level landing/take-off surface for the operation of the UAS. The invention will keep the UAS clean. The invention is designed to aid the UAS in landing and take-off approach. The invention has safety labeling. The invention has internal power for electronics. The UAS ground support platform has rain gutters to help maintain a dry top surface. The UAS ground support platform is designed to support the delivery UAS and the package. By simply placing the UAS ground support platform in a space, you are creating a designated UAS landing/take off zone which promotes personal safety. Although the UAS ground support platform is portable, it can be hard mounted by use of a bracket.

### BRIEF DESCRIPTION OF THE SEVERAL VIEWS OF THE DRAWING

FIG. 1. Isometric view illustrating top and sides.

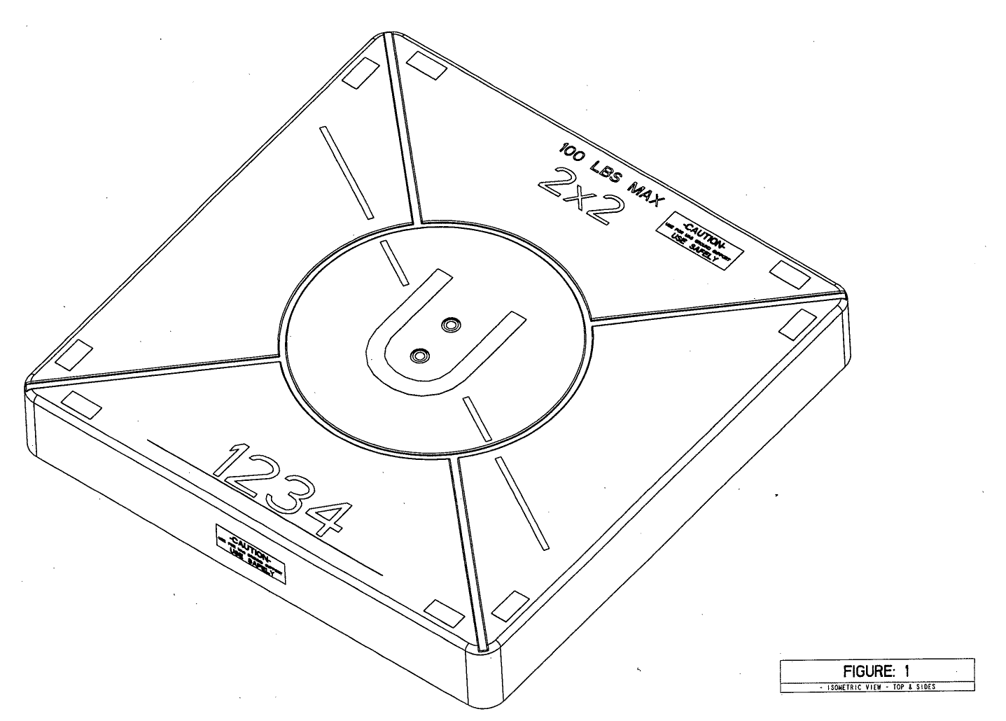

FIG. 2. Isometric view illustrating bottom and sides.

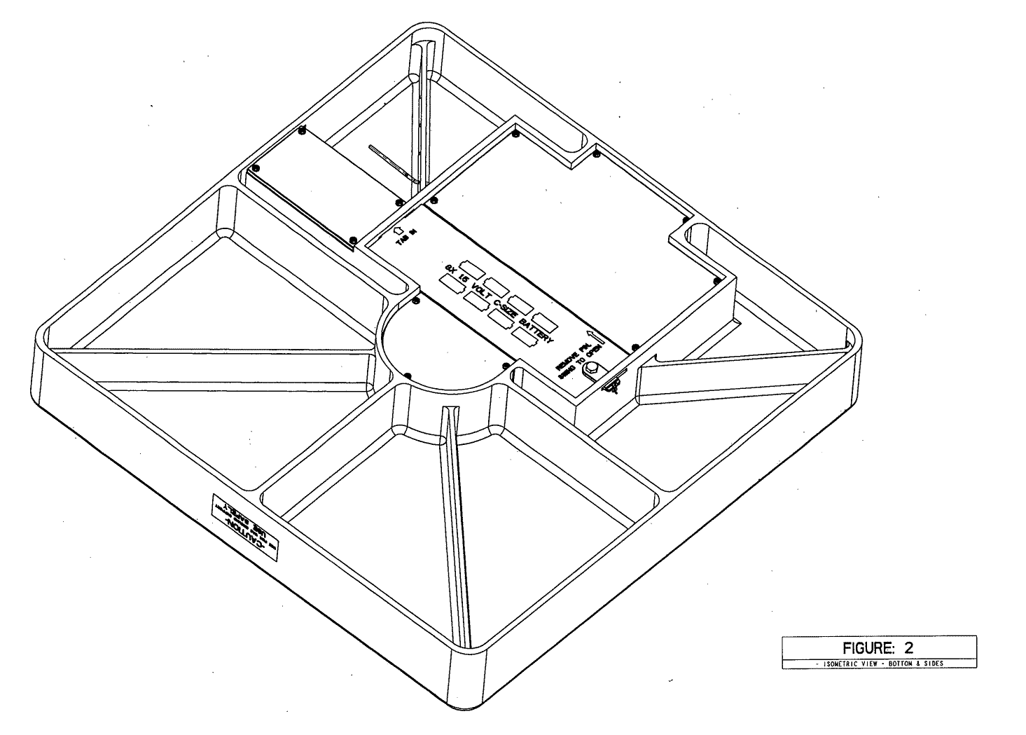

FIG. 3. Isometric, detailed top view.

FIG. 4. Isometric, detailed bottom view.

FIG. 5. Detailed side view illustrating power on/off switch and 12 volt DC adapter receptacle.

FIG. 6. Isometric, detailed view of bottom and side with the covers removed.

FIG. 7. 3D view of electrical components with 2D schematic.

FIG. 8. Front page view, color solid model.

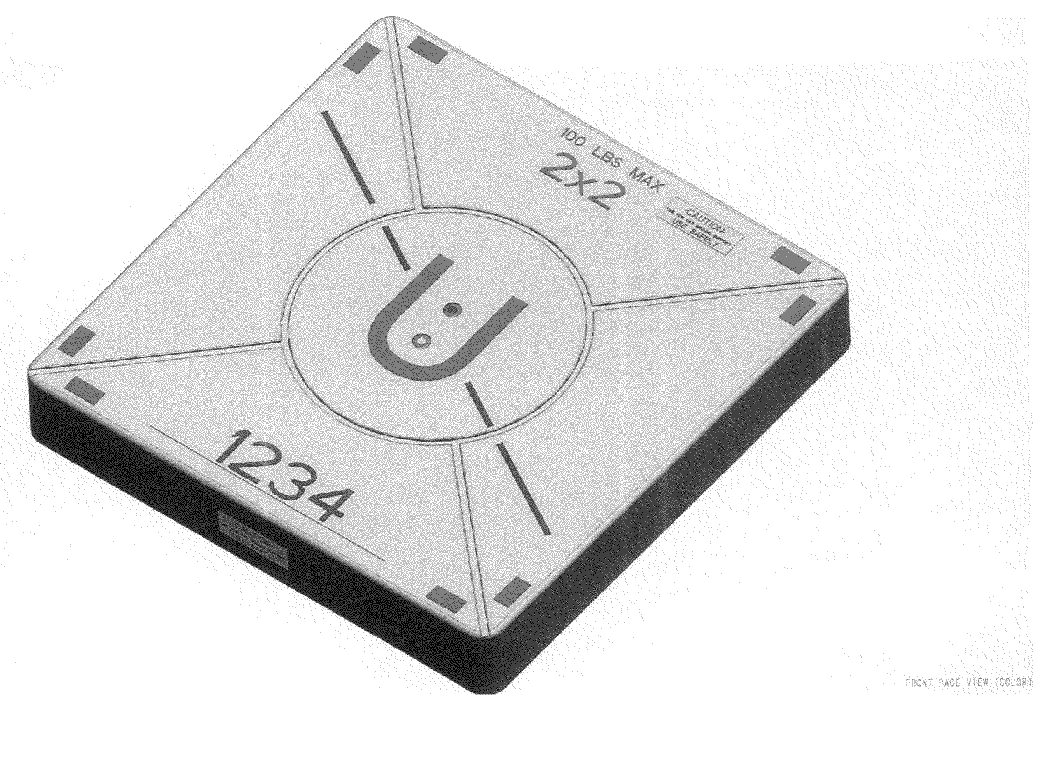

FIG. 9. Front page view, black and white.

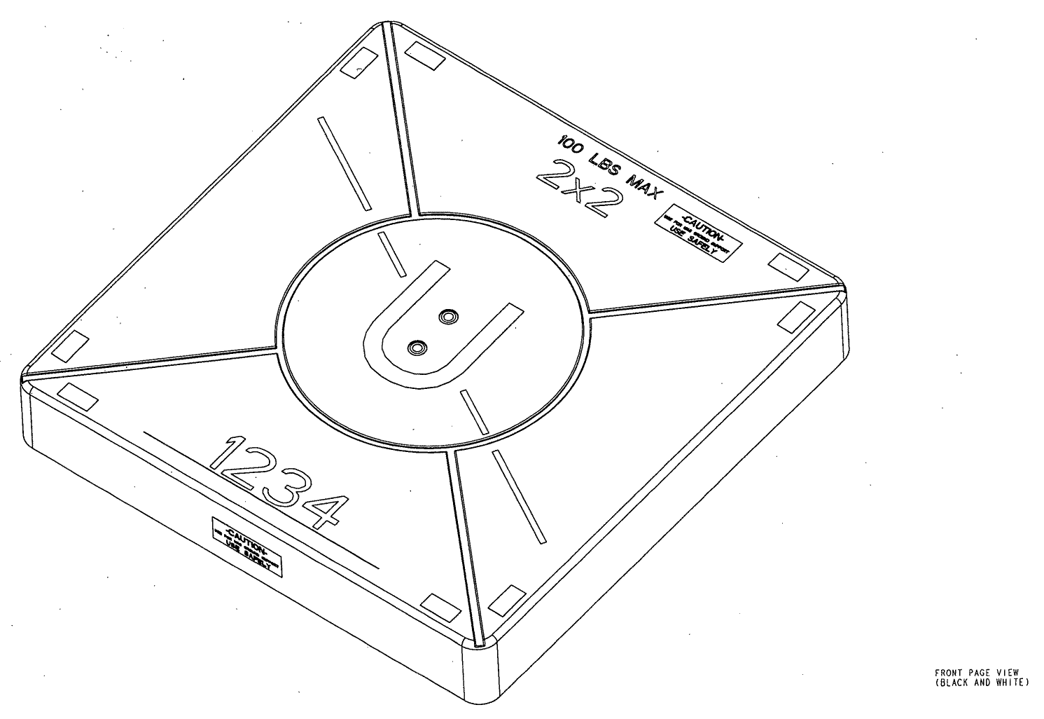

FIG. 10. 3D view of UAS ground support platform hard mounted to a wall by a support bracket.

### DETAILED DESCRIPTION OF THE INVENTION

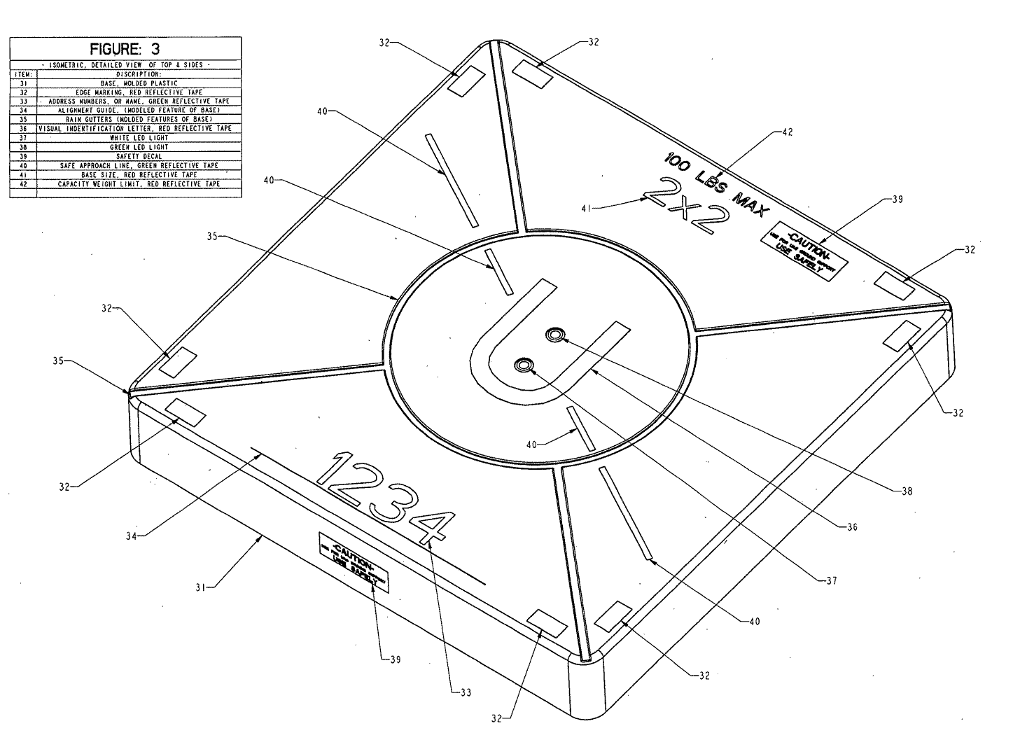

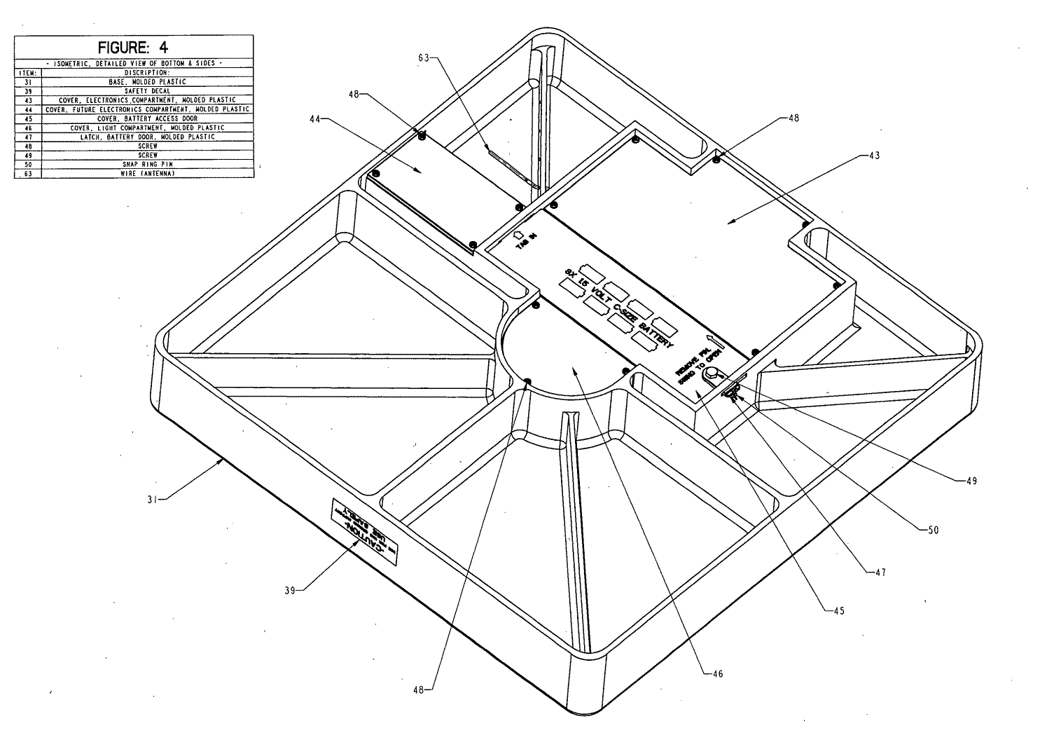

For portability and low weight, the UAS ground support platform consist of a sturdy base of Molded plastic, FIG. 3, item 31. The base is reinforced with several ribs and electronic compartments on the underside, FIG. 4. Modeled plastic covers protect the bases compartments. One of the support ribs holds the remote switch receiver antenna in a winding pattern through the holes. The platforms plastic color will be different for weather resistance in various climate regions.

Although the base is designed for a UAS and its payload with a capacity of 100 pounds maximum, the base is designed to support a 250 pound person standing on it.

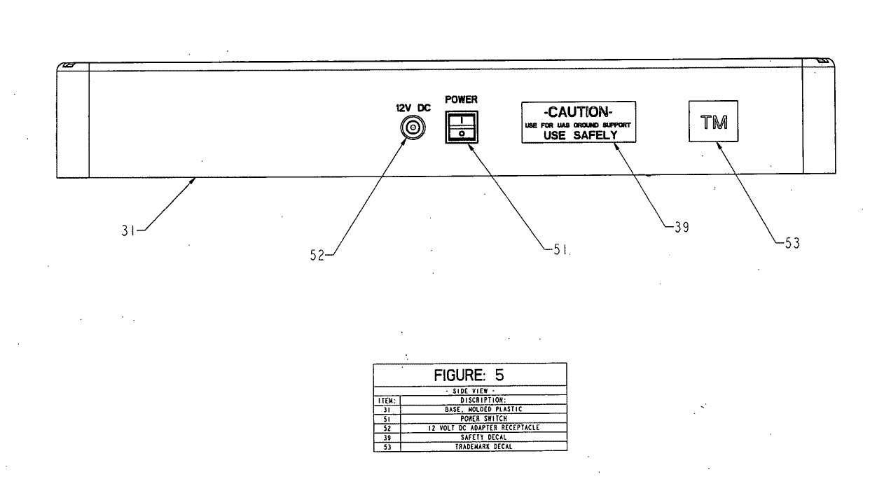

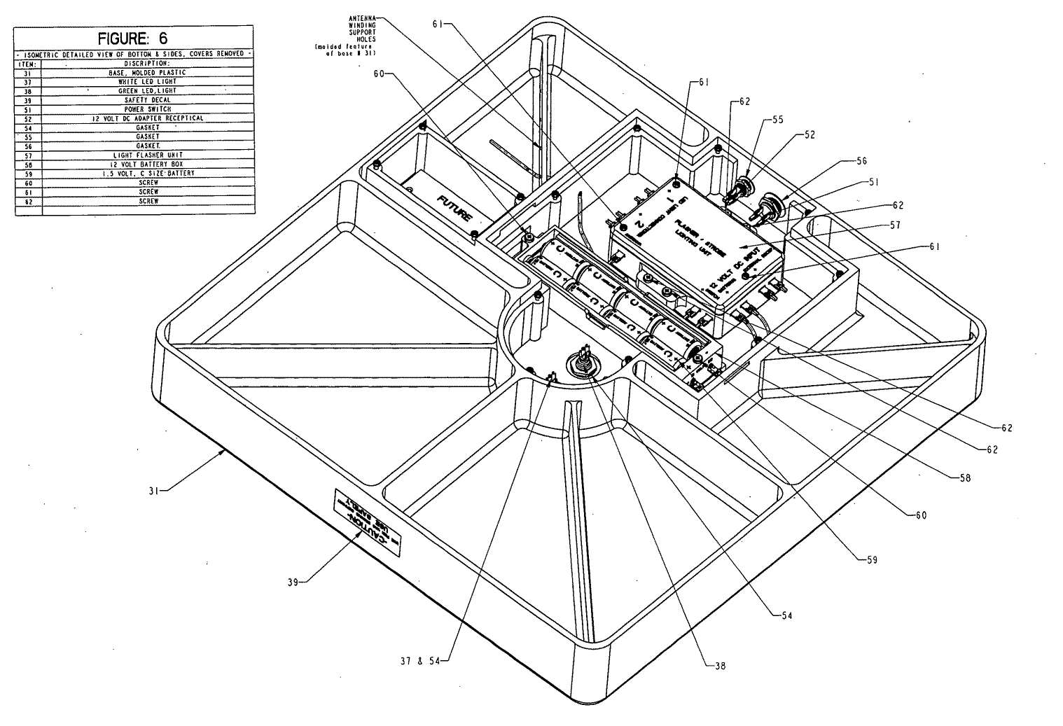

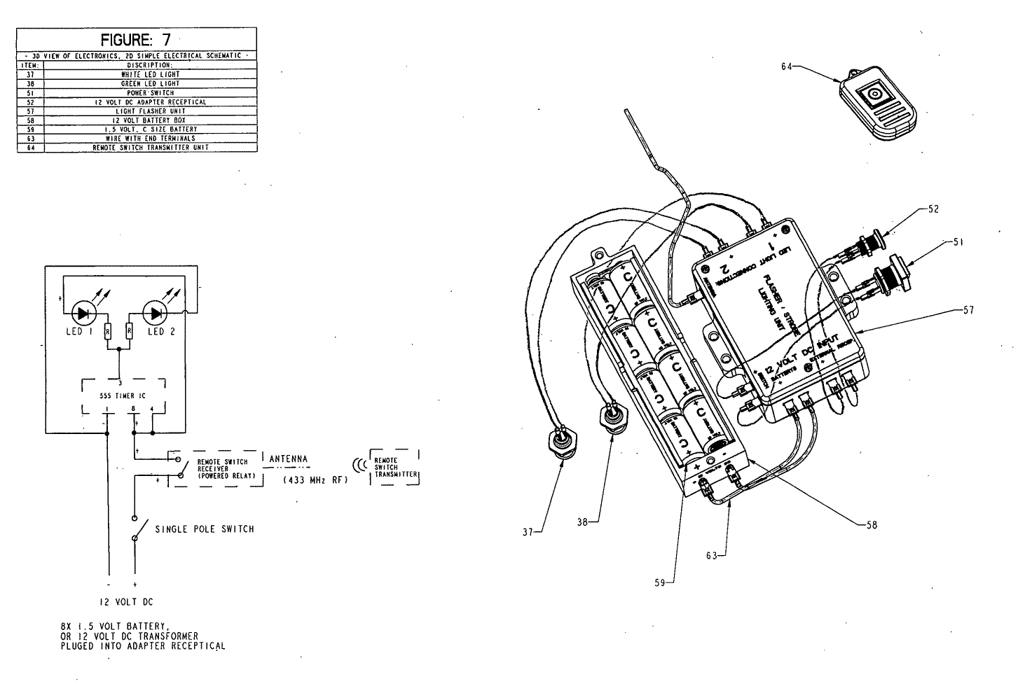

Electronics are located inside the bases compartments, FIG. 6. The lighting unit controls the two led top surface center mounted lights. The lights can be turned on from a switch on the side of the base, FIG. 5, or by remote transmitter switch, FIG. 7.

The LED light colors are white and green, FIG. 3. The lights are mounted flush to the top surface so they will not interfere with UAS (Drone, UAV) flight operations. The lights illuminate the base platform.

The letter “U” in red reflective material in the center of the top surface is an aerial and ground support visual identification symbol which stands for “Unmanned Aircraft Systems”, FIG. 3. This main identifier symbol on the top surface will indicate to UAS pilots, ground support personal and the public that this is a UAS landing/take off zone.

FIG. 3, item 33 depicts reflective letters and numbers. The numbers and letters are placed on the top surface, bottom along the molded alignment guide to provide platform ownership. Home, or business address numbers are preferred, but names and other forms of identification are up to the owner.

FIG. 3, item 41, is a red reflective platform is a top surface platform size identifier. 2×2 indicates a platform size of two foot square. 3×3 indicates three foot square.

FIG. 3, item 32 are red reflective shapes on the top surface to indicate the edges and corners of the platform.

FIG. 3, item 35 are rain gutters. They are molded features of the base platform. Their purpose is to drain water away for a dry top surface.

FIG. 3, item 40 is a green reflective safe approach line for landings and take offs. The owner places the line on the top surface to aid the UAS pilot with an approach heading, or take off heading clear of obstacles such as trees and buildings.

The UAS ground support platform electronic system is powered by internally housed batteries. See FIG. 6. The batteries are easily replaced by means of a battery door on the underside of the platform base. An external transformer adapter receptacle is provided for power also, FIG. 5.

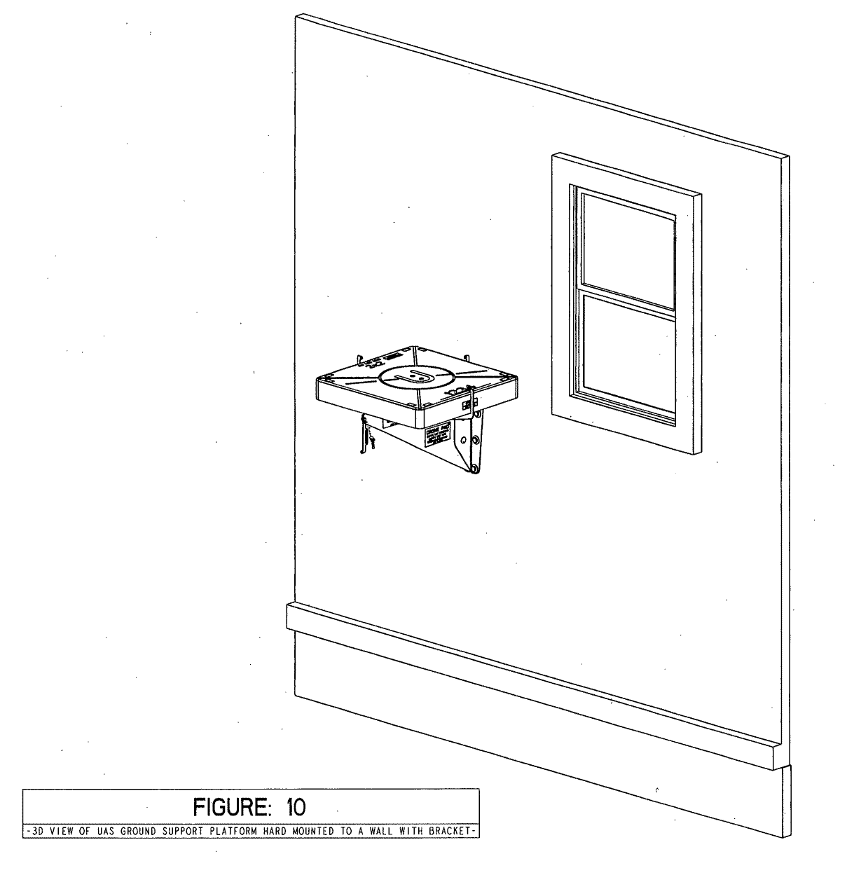

The UAS ground support platform can be hard mounted by means of a bracket. One example is show in FIG. 10. The bracket is designed to allow the base platform to be portable again by way of a hinged feature.

Safety decals and labels for personal and public safety are located on the top and side of the base platform.

The UAS ground support platform will promote and sustain UAS operational cleanliness and illumination while providing stability and product ownership in a safe manner.

1. The Unmanned Aircraft Systems ground support platform is a multifunctional apparatus to accommodate UAS (Drone, UAV) landings, takeoffs, idle time, maintenance, retail merchandise product display and package delivery within the UAS recreational and business industry.

2. The Unmanned Aircraft Systems ground support platform of claim 1 is portable.

3. The Unmanned Aircraft Systems ground support platform of claim 1 is internally powered.

4. The Unmanned Aircraft Systems ground support platform of claim 1 base platform material is plastic.

5. The Unmanned Aircraft Systems ground support platform of claim 1 has rain gutters that are molded into the top surface of the base platform to maintain a dry top surface.

6. The Unmanned Aircraft Systems ground support platform of claim 1 has two offset center mounted flashing LED lights embedded flush to the top surface of the base to aluminate the unit.

7. The Unmanned Aircraft Systems ground support platform of claim 1 has a center mounted, top surface visual identification symbol: “U”.

8. The Unmanned Aircraft Systems ground support platform of claim 1 has top surface base platform maximum weight capacity information.

9. The Unmanned Aircraft Systems ground support platform of claim 1 has a molded feature on the bottom area, top surface of the base to aid alignment of address numbers, or letters.

10. The Unmanned Aircraft Systems ground support platform of claim 1 has numbers and/or letters on the bottom area, top surface for identifying home address, or name for product ownership.

11. The Unmanned Aircraft Systems ground support platform of claim 1 has platform size identification on the top surface.

12. The Unmanned Aircraft Systems ground support platform of claim 1 is a standalone structure, no external support is necessary.

13. The Unmanned Aircraft Systems ground support platform of claim 1 lights can be turned on and off by a remote transmitter switch.

14. The Unmanned Aircraft Systems ground support platform of claim 1 has molded base compartments with covers for the unit's electronics.

15. The Unmanned Aircraft Systems ground support platform of claim 1 has an electronic light flashing controller.

16. The Unmanned Aircraft Systems ground support platform of claim 1 contains a green safe flight approach and departure line on the top surface of the base platform.

17. The Unmanned Aircraft Systems ground support platform of claim 1 contains safety decals on the top surface and sides of the base platform.

18. The Unmanned Aircraft Systems ground support platform of claim 1 contains a DC voltage adapter receptacle on side of the base platform.

19. The Unmanned Aircraft Systems ground support platform of claim 1 has a modeled feature of the base platform to wind the remote switch receiver antenna in and out the base support rib.

20. The Unmanned Aircraft Systems ground support platform of claim 1 has a power switch on the side of the base platform.

21. The Unmanned Aircraft Systems ground support platform of claim 1, the top surface “U” letter is a visual aerial pilot, ground support and public identification symbol standing for an “Unmanned Aircraft Systems landing zone”.

22. The Unmanned Aircraft Systems ground support platform of claim 1 base platform top surface size is two foot square (2′×2′).

23. The Unmanned Aircraft Systems ground support platform of claim 1, another base platform top surface size is three foot square (3′×′3′).

24. The Unmanned Aircraft Systems ground support platform of claim 1, although portable and self-supporting it can be hard mounted to a surface by means of a bracket.

25. The Unmanned Aircraft Systems ground support platform of claim 1 has eight edge reflectors, two per corner on the perimeter of the top surface of the base platform.

26. The Unmanned Aircraft Systems ground support platform of claim 1 has a trademark decal on the side of the base platform.

27. The Unmanned Aircraft Systems ground support platform of claim 1, base platforms plastic color will be different for weather resistance in various climate regions. Dark colors for cold climate regions, light colors for hot climate.
